(19) United States
(12) Patent Application Publication
(10) Pub. No.: US 2008/0092890 A1
(43) Pub. Date: Apr. 24, 2008

(54) EMERGENCY ESCAPE BREATHING DEVICE

(76) Inventor: Daniel SHAHAF, Dogania (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/769,848

(22) Filed: Jun. 28, 2007

Related U.S. Application Data
(63) Continuation-in-part of application No. PCT/IL05/01384, filed on Dec. 27, 2005.
(60) Provisional application No. 60/639,296, filed on Dec. 28, 2004.

(51) Int. Cl. A62B 7/02; A62B 23/00

(52) U.S. Cl. 128/204.15; 128/205.28

(57) ABSTRACT

An emergency escape breathing device comprises an oxygen bottle configured to contain compressed oxygen, an oxygen release regulator configured to release of the compressed oxygen at a constant rate during use of the emergency escape breathing device, the oxygen release regulator being substantially contained within the oxygen bottle.

### CROSS-REFERENCE TO RELATED APPLICATIONS

This application is a continuation in part of PCT/IL2005/001384, entitled “Positive Flow Rebreather” and fled Dec. 27, 2005. The aforementioned International Application claims priority to U.S. Provisional Application No. 60/639,296, filed Dec. 28, 2004. The contents of each of the above-identified applications is incorporated herein by reference in their entirety.

### FIELD AND BACKGROUND OF THE INVENTION

The present invention relates to emergency escape breathing devices. More specifically the present invention relates to emergency escape breathing devices that cool the air during inhalation, have protected oxygen regulators and large counter lung capacities.

An emergency escape breathing device, also referred to herein as a rebreather, supplies recycled purified air to a user by adsorbing CO₂ (carbon dioxide) from expired air and enriching the air with O₂ (oxygen) in a closed loop system. Emergency escape breathing devices provide the purified air to the user for a limited time during escape from a hostile environment, for example a smoke-filled building posing imminent danger to breathing.

Rebreathers include a flexible bladder, herein a counter lung, connected to an adsorption canister, having a manifold, that covers and/or is inserted into, a user mouth. Expired air, while passing from the canister to the counter lung, is recycled for inspiration by adsorbing CO₂ and providing enrichment with O₂.

CO₂, primarily in the form of carbonic acid dissolved in water vapor, is adsorbed in the adsorption canister containing soda-lime. Soda-lime is a mixture of 94% calcium hydroxide, 5% sodium hydroxide and 1% potassium hydroxide. The canister additionally contains water for dissolving the undissolved CO₂ gas for adsorption; silica to preserve the granularity of the soda-lime; and a pH sensitive dye that indicates exhaustion of the soda-lime.

CO₂ adsorption occurs through the following chemical reactions:

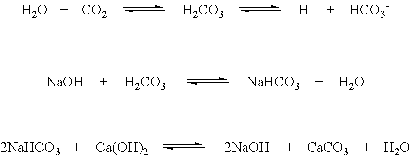

Calcium hydroxide adsorbs the majority of the CO₂ while sodium hydroxide and potassium hydroxide accelerate the rate of CO₂ adsorption. The above noted chemical reaction is exothermic, with the temperature of the soda-lime quickly reaching and maintaining a temperature of about 140 degrees Fahrenheit.

Following CO₂ adsorption, O₂ gas is introduced into the purified air from an O₂ bottle and the air, purified of CO₂ and enriched with O₂ is inspired by the user; thereby providing an efficient solution in a difficult breathing environment.

While rebreathers have many advantages over bulky O₂ tanks, air tanks and pollutant-filtered masks, rebreathers are not without drawbacks.

In addition to purifying exhaled air, the counter lung serves as a reservoir that allows the user continued breathing after the O₂ from the O₂ bottle has been exhausted A large-size counter lungs provides more time for the user to escape the inhospitable environment prior to exhausting the purified air. A large-size counter lung, however, adds considerable weight to the rebreather, hindering a fast escape from the hostile environment.

To cut down on weight, counter lungs are configured with small volumes, an example of which is seen in U.S. Pat. No. 4,440,163 (Spergel), the disclosure of which is incorporated herein by reference; thereby reducing the amount of purified air than can be utilized following exhaustion of the O₂ stream.

Another problem related to the counter lung is that during continual recycling of the user's expired air, the air contained in the counter lung continually absorbs the heat of the user's body temperature in the exhaled air and the purified air for inhalation rises to a temperature that is uncomfortable for the user.

More problematic; the exothermic reaction required for CO₂ adsorption, noted above, adds significant heat to the air in the closed loop, causing the air to become uncomfortably hot. Additionally, environmental heat can raise the rebreather temperature even higher; for example, when a rebreather is administered in the presence of the searing heat of a raging fire. In such applications, the overly heated air in the closed loop may not only be uncomfortable, but hazardous; contributing to user panic that may result in irreversible shock.

Over heated recycled rebreather air accrues two additional problems; the first problem being inadequate mixture of O₂ with the inspired air. The O₂ gas, by virtue of expanding from the tank, is cooler and heavier than the over-heated expired air in the counter lung. The heavier cool O₂ sinks to the bottom of the counter lung while the lighter hot non-enriched expired air rises and covers the air intake at the top of the counter lung. With non-enriched hot exhaled air primarily entering the air intake, the user is deprived of necessary O₂.

The second problem associated with overheated air is inefficient adsorption of CO₂. As the soda lime granules become heated from the exothermic reaction associated with CO₂ adsorption, the efficiency of the granules is reduced, resulting in less adsorption of CO₂. Additionally as the air expands due to the heat, the expired air is propelled out of the adsorption canister, resulting in even less efficient adsorption of CO₂.

Inefficient CO₂ adsorption and poor mixing of O₂ with the expired air, both resulting from overly hot exhaled air, may cause user hypoxia and associated sequela.

U.S. Pat. No. 4,314,566 to Kiwak discloses a rebreather system having an externally located heat exchanger system; and U.S. Pat. No. 5,269,293 to Loser et al. discloses a rebreather system having an external zeolite adsorbent cooling system, the disclosure of both of which are hereby incorporated in their entirety. Both rebreather systems provide a potential solution to overheating but unfortunately add considerable weight, bulk, size and/or expense to the rebreather.

In addition to all the problems associated with the exothermic adsorption of CO₂, there are problems associated with a breathing cycle demand valve on the O₂ bottle that opens to release O₂ gas during each rebreathing cycle.

The first problem is that breathing cycle demand valves are complex and open and close with each breathing cycle, making the valves prone to malfunction. The second problem is that breathing cycle demand valves are heavy, adding unwanted weight to a rebreather. The third problem is that the breathing cycle demand valve only opens following expiration. If a user begins the first breathing cycle with an inspiration, as opposed to an expiration, the user is provided with nothing to inspire; likely resulting in a bout of choking that further deprives the user of life-sustaining air.

U.S. Pat. No. 6,712,071 to Parker teaches an oxygen sensor and injector system for ensuring proper oxygen content; and U.S. Pat. No. 6,003,513 to Readey et al teaches a stepper-motor controlled variable flow rate system to maintain O₂ at a constant level; the disclosure of both of which are hereby incorporated by reference. In addition to adding weight, bulk and complexity, both patents teach systems that add significant bulk to the rebreather and only begin functioning following at least one exhalation, thereby failing to prevent choking on the first inhalation when the counter lung has yet to fill with O₂.

In addition to the above, existing emergency escape breathing devices have compressed, dry or liquid, O₂ in a bottle that once activated provides a constant flow of approximately 1.2-1.5 liters of O₂ per minute throughout use of the emergency escape breathing device. The key to providing the O₂ at this constant rate is a regulator on the O₂ bottle; a sensitive part of the emergency escape breathing device that can malfunction due to knocks or bangs during storage or use of the emergency escape breathing device.

U.S. Pat. Nos. 7,140,591, and 6,997,348 (Droppleman), the entirety of which are incorporated herein by reference, teach emergency escape breathing devices having a vulnerable O₂ regulator which, during storage for a period of up to 15 years, or during use, may be knocked or banged, causing malfunction. A malfunctioning O₂ regulator will deny the user purified air in a hostile environment and may result in death of the user.

In addition, the above-noted patents have O₂ bottles that heat up due to a high environmental temperature and the user may receive a burn upon touching the O₂ bottle.

In summary, while providing an efficient breathing system, rebreathers have failed to solve fundamental problems, including providing air:

at a comfortable temperature;

efficiently purified of CO₂;

property mixed with O₂;

upon a first inspiration;

in a large size reservoir;

in an impact-resistant O₂ bottle; and

through a robust O₂ regulator.

### SUMMARY OF THE INVENTION

The present invention successfully addresses at least some of the shortcomings of the prior art with a rebreather having a simple, durable and lightweight construction; providing air efficiently purified of CO₂ and properly enriched with O₂, at a comfortable temperature from the very first inspiration and for an extended period.

Further, embodiments of the emergency escape breathing device include an O₂ regulator that is fully contained within the O₂ bottle, thereby protecting the O₂ regulator from knocks and bangs during storage or use, thereby substantially preventing malfunction.

In additional embodiments, the O₂ bottle is contained in at least one housing that protects the O₂ bottle against impact and/or heat buildup.

Further, the emergency escape breathing device of the present invention includes a compact counter lung that assumes large volume in an expanded configuration, allowing the counter lung to assume a large inflated volume while conserving space and weight.

According to one aspect of an embodiment of the invention, there is provided an emergency escape breathing device, comprising an oxygen bottle configured to contain compressed oxygen, an oxygen release regulator that releases the compressed oxygen at a constant rate during use of the emergency escape breathing device, the oxygen release regulator being substantially contained within the oxygen bottle.

In embodiments, the oxygen bottle comprises a substantially monotonous configuration.

In embodiments, the oxygen bottle is contained within a protective housing.

In embodiments, the protective housing is configured to protect the oxygen bottle against at least one of impact, and heat buildup.

In embodiments, the oxygen bottle is configured to contain dry oxygen.

In embodiments, the oxygen release regulator is configured to release the dry oxygen at the constant rate.

In embodiments, the device includes a counter lung comprising a chamber, the chamber in an unexpanded configuration being enclosed by at least two substantially parallel walls and a perimeter connecting the at least two substantially parallel walls, the perimeter including at least one fold that substantially extends into the chamber.

In embodiments, when the chamber is in an expanded configuration, the at least one fold substantially unfolds and at least a portion of the two walls diverge. In embodiments, the device includes forward and backpass valves operatively associated with the counter lung.

In embodiments, the forward and backpass valves promote a circular airflow within the device.

In embodiments, the regulator includes a rapid release demand valve that releases a burst of oxygen in response to light pressure.

In embodiments, the rapid release demand valve releases the burst of oxygen at a faster rate than the release of oxygen by the regulator.

In embodiments, the rapid release demand valve releases the oxygen in response to pressure from the counter lung.

According to another aspect of an embodiment of the invention, there is provided an emergency escape breathing device, comprising a counter lung comprising a chamber, the chamber in an unexpanded configuration being enclosed by at least two substantially parallel walls and a perimeter connecting the at least two substantially parallel walls, the perimeter including at least one fold that substantially extends into the chamber.

In embodiments, when the chamber is in an expanded configuration, the at least one fold substantially unfolds and at least a portion of the two walls diverge.

According to a still further aspect of an embodiment of the invention, there is provided an emergency escape breathing device, comprising an oxygen bottle configured to contain compressed oxygen, an oxygen release regulator configured to release the compressed oxygen at a constant rate during use of the emergency escape breathing device, the oxygen release regulator being substantially contained within the oxygen bottle, and a counter lung comprising a chamber, the chamber in an unexpanded configuration being enclosed by at least two substantially parallel walls and a perimeter connecting the at least two substantially parallel walls, the perimeter including at least one fold that substantially extends into the chamber.

In embodiments, when the chamber is in an expanded configuration, the at least one fold substantially unfolds and at least a portion of the two walls diverge.

In embodiments, the oxygen bottle comprises a substantially monotonous configuration.

In embodiments, the oxygen bottle is contained within a protective housing.

In embodiments, the protective housing is configured to protect the oxygen bottle against at least one of impact, and heat buildup.

According to still another aspect of an embodiment of the present invention there is provided a closed-loop rebreather, having a housing that includes a CO₂ adsorbing canister and a counter lung extending from the housing.

In an embodiment, the housing and counter lung are assembled so that during operation expired air passes through the canister, where a volume of CO₂ from the expired air is adsorbed. The air then passes into the counter lung and from the counter lung through a passage in the housing.

Additionally, there is provided a bottle of compressed O₂ operatively to associated with the housing and adapted to continuously release O₂ gas into the counter lung during the operation.

In an embodiment, the rebreather includes a valve on the bottle that remains open during the operation and the O₂ gas substantially fills the counter lung in the beginning of the operation, and/or prior to the first inspiration.

In a further embodiment, the continuous release is adapted to cool the bottle and the cooled bottle includes a passage through which the inspired air passes, thereby cooling the inspired air.

Additionally the inspired air retains the cooling in the closed-loop as the expired air passes through the canister, thereby increasing the volume of adsorbed CO₂.

In still another embodiment, the rebreather includes an elongate sleeve extending from the canister substantially into the counter lung, the sleeve having an opening substantially distant to the canister. The expired air passes through the canister, through the sleeve and into the counter lung.

In a further embodiment, the sleeve is adapted to cause the expired air to substantially mix with the released O₂ gas in the counter lung, ensuring that the O₂ is substantially mixed with the air.

Additionally, the sleeve creates impedance as the expired air passes through the sleeve, the impedance causing the expired air to pass more slowly through the sleeve and the canister, thereby increasing the volume of adsorbed CO₂.

In an additional embodiment, the sleeve further includes at least one restriction, the restriction causing the expired air to pass more slowly through the sleeve and the canister, thereby increasing the volume of adsorbed CO₂.

According to another aspect of an embodiment of the present invention there is provided a method for cooling for air in a closed loop rebreather, comprising continuously expanding O₂ gas from a bottle of compressed O₂ gas, cooling the bottle with the expanding O₂ gas, passing a volume of warm air proximate to the bottle, exchanging heat between the volume and the bottle, and cooling the volume.

In an embodiment, the method further includes continuously releasing the O₂ from the bottle.

In still a further aspect of an embodiment of the present invention, a closed-loop rebreather comprises a housing that includes a CO₂ adsorbing canister and a bottle of compressed O₂ adapted to release O₂ gas. The rebreather further includes a counter lung extending from the housing, and an elongate sleeve extending from the canister substantially into the counter to lung. The rebreather is assembled such that expired air passes through the canister, where a volume of CO₂ from the expired air is adsorbed, the air continues into the counter lung and the bottle releases O₂ gas into the counter lung.

In a further embodiment, the sleeve is adapted to cause the adsorbed air to substantially mix with the released O₂ in the counter lung. Additionally, the sleeve creates impedance as the expired air passes, the impedance causing the expired air to pass more slowly through the sleeve and the canister, thereby increasing the volume of CO₂ adsorbed from the expired air.

In still an additional embodiment, the sleeve further includes at least one restriction, the restriction causing the expired air to pass more slowly through the sleeve and the canister, thereby increasing the volume of CO₂ adsorbed from the expired air.

In an additional embodiment, a valve is included on the bottle that remains open during the operation and the bottle is adapted to continuously release O₂ gas into the counter lung during the operation.

In a further embodiment, the O₂ gas substantially fills the counter lung in at least one of at the beginning of the operation and prior to the first inspiration.

Optionally, the O₂ bottle is adapted to release O₂ gas in a manner that cools the compressed O₂ bottle. In a further embodiment, the cooled bottle includes a passage through which the inspired air passes, thereby cooling the inspired air.

In still a further embodiment, the inspired air retains the cooling in the closed-loop as the expired air passes through the canister, thereby increasing the volume of CO₂ adsorbed.

According to an additional aspect of an embodiment of the present invention there is provided a method for substantially mixing expired air with O₂ in a rebreather. The method comprises passing O₂ into a counter lung, extending a sleeve substantially into a counter lung, passing expired air through the sleeve into the counter lung and substantially mixing the air with the O₂.

The present invention successfully addresses the shortcomings of the presently known configurations by providing an emergency escape breathing device having a protected O₂ regulator, protected O₂ bottle, inspired air cooling system and a compact counter lung having a large inflation volume.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWING

The invention is by way of example only, with reference to the accompanying drawing. With specific reference now to the drawing in detail, it is stressed that the particulars shown are by way of example and for purposes of illustrative discussion of the preferred method of the present invention only, and are presented in the cause of providing what is believed to be the most useful and readily understood description of the principles and conceptual aspects of the invention.

In this regard, no attempt is made to show structural details of the invention in more detail than is necessary for a fundamental understanding of the invention, the description taken with the drawings making apparent to those skilled in the art how the methods of the invention may be embodied in practice.

Exemplary non-limiting embodiments of the invention described in the following description, read with reference to the figure attached hereto. Dimensions of components and features shown in the figure are chosen primarily for convenience and clarity of presentation and are not necessarily to scale.

The attached figures are:

FIG. 1 is a cross sectional view of an O₂ bottle housing, according to embodiments of the invention;

FIG. 2 is a cross sectional view of an O₂ bottle and regulator, according to embodiments of the invention;

FIGS. 3-4 are a cross sectional view and plan view, respectively, of a counter lung, according to embodiments of the invention;

FIG. 5 is a schematic drawing of an emergency escape breathing device, according to embodiments of the invention; and

FIG. 6 is a schematic drawing of alternative design of the emergency escape breathing device shown in FIG. 5, in accordance with an embodiment of the present invention.

### DESCRIPTION OF EXEMPLARY EMBODIMENTS

The present invention relates to a rebreather with simple, trouble-free parts and operation; that efficiently adsorbs CO₂ from expired air; substantially continuously mixes O₂ into the expired air; and supplies air for inspiration to the user at a comfortable temperature.

Referring now to the drawings:

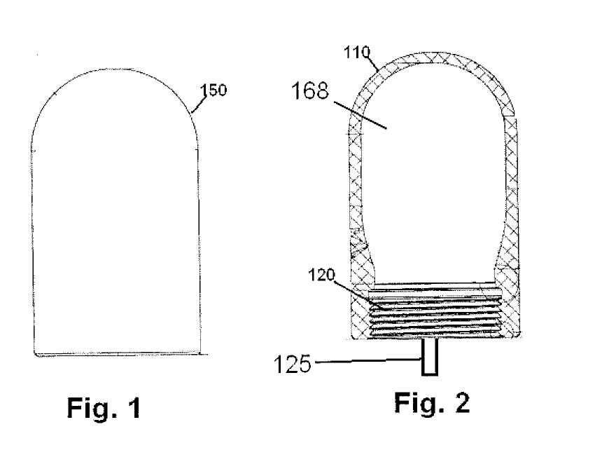

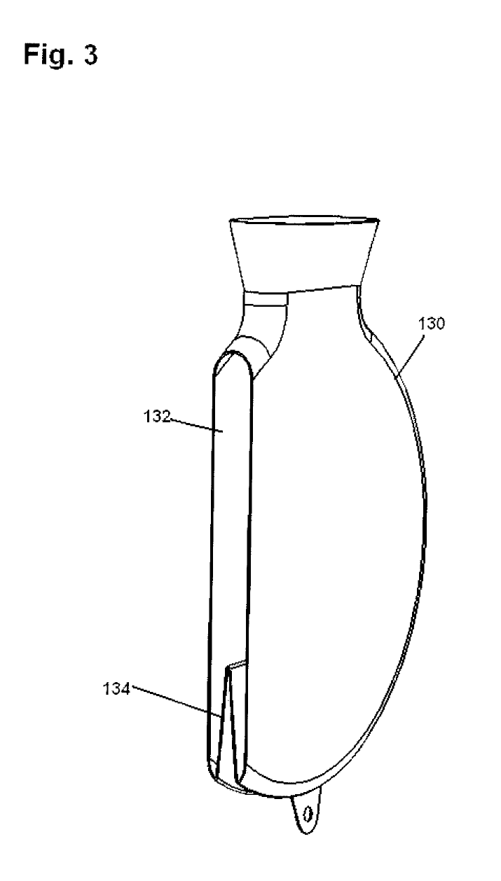

FIG. 1 shows a protective O₂ bottle housing 157 that substantially surrounds an O₂ bottle 110, shown in FIG. 2. O₂ bottle 110 has a reservoir containing compressed dry O₂ and a regulator 153 that is submerged within, and hence substantially protected by, O₂ bottle 110. Submerged regulator 153 is substantially protected from damage due to bangs and bumps for example during a long regulator storage period, for example 10 to 15 years noted above, or during use.

In alternative embodiments, O₂ bottle 110 is configured to contain a reservoir of compressed liquid O₂ and regulator 153 is configured to release compressed liquid O₂ at a constant rate.

In embodiments, O₂ bottle 110 has a substantially monotonous configuration; the term substantially monotonous meaning herein, that the diameter of O₂ bottle 110 comprises a cylinder having substantially the same cross sectional diameter from at least mid cylinder to regulator 153. In such monotonous configurations, O₂ bottle 110 has a substantially robust configuration that prevents damage from impact.

Regulator 153, as noted above, releases a stream of O₂ at a rate of about approximately 1.2-1.5 liters of O₂ per minute although other rates of release may be incorporated into regulator 153.

Additionally, regulator 153 includes a rapid release demand valve 125, comprising a post connected to a mechanism (not shown), that functions to release a rapid burst of O₂ 168 from O₂ bottle 110 at approximately 80 liters of O₂ in addition to the constant release of O₂ 168 by regulator 153, noted above.

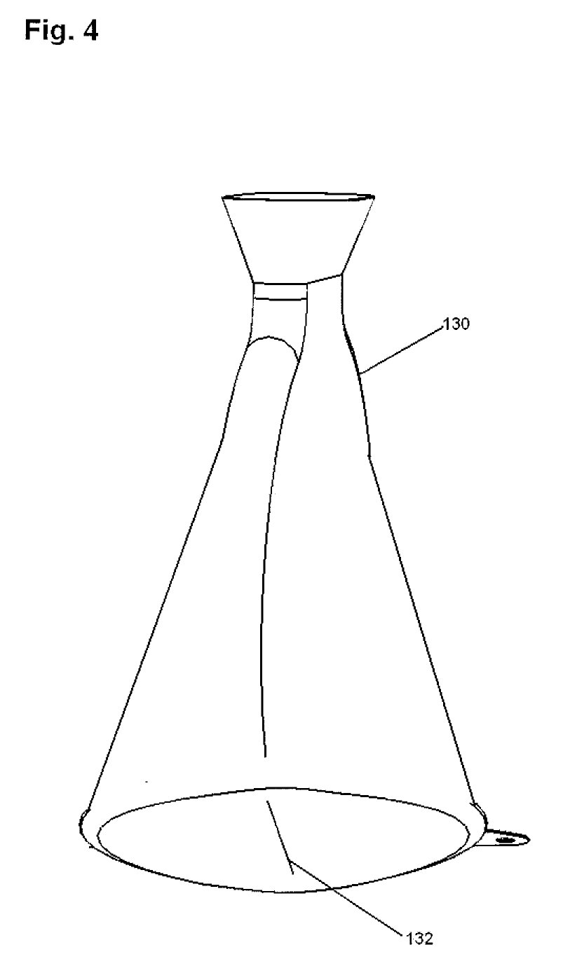

FIG. 3 shows a counter lung 160 enclosing a chamber 142 having a folded portion 134. Counter lung 160 is substantially compact and lightweight, having a weight of between 0.5 kilograms and 1.2 kilograms. While counter lung 150 is shown as having a substantially circular perimeter, counter lung 150 optionally has other perimeter configurations, including triangular, square or other polygon shapes.

FIG. 4 shows counter lung 160 in an expanded configuration as would be the case during use. Folded portion 134 has unfolded to increase the size of counter lung 160 to contain a volume of between 8 and 12 liters.

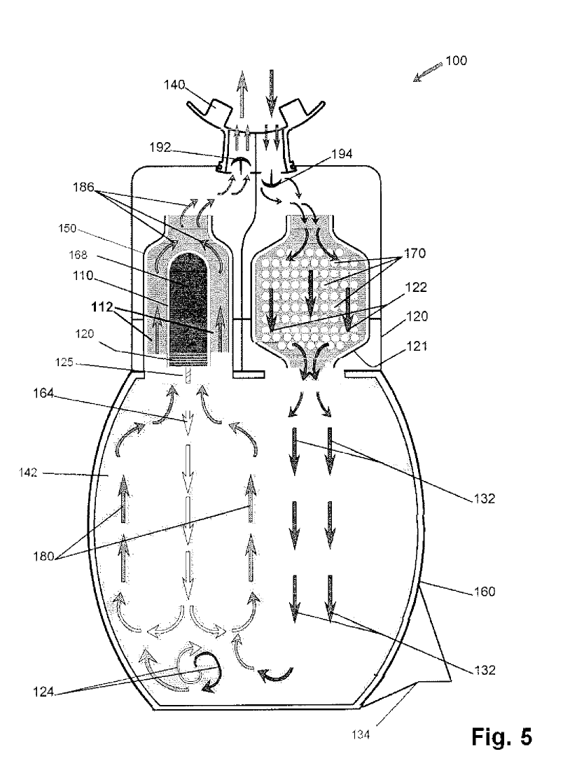

FIG. 5 is a schematic drawing of an emergency escape breathing device 100, also referred to as a self contained breathing apparatus (SCBA), comprising a canister housing 120 containing a CO₂ adsorbing canister 121.

CO₂ adsorbing canister 121 has an airflow passage therethrough, the flow passage containing a CO₂ adsorbent material 170 adapted to adsorb CO₂ from expired air 122.

CO₂ laden exhaled air 122 passes forward from a mouthpiece 140 through canister 121, into a counter lung 160. Within canister 121, CO₂ molecules, primarily in the form of carbonic acid, are substantially adsorbed by adsorbent material 170 comprising soda-lime granules in an exothermic reaction yielding purified air 132.

As used herein:

“CO₂ adsorbing canister” refers to a canister having a flow passage there through and containing a CO₂ adsorbent material;

“CO₂ adsorbent material” refers to any material that substantially adsorbs CO₂, including, but not limited to soda lime;

“substantially adsorbs CO₂” refers to adsorption of a substantial percentage of CO₂, such that, by way of example, if expired unpurified air volume 122 contains 3% CO₂, purified air volume 132 contains between about 1% and 2% CO₂; and

“purified air” refers to air 132 from which CO₂ has been substantially adsorbed.

In embodiments, a compressed volume of O₂ 168 in O₂ bottle 110 is continually released during operation of emergency escape breathing device 100 through regulator 153 as noted above. Regulator 153 typically has a simple, lightweight and robust design and, as noted above, is embedded in O₂ bottle 110. Regulator 153 assumes an open position to begin the release of O₂ 168 and remains open throughout operation of emergency escape breathing device 100.

In addition to protecting regulator 153, recessing regulator into O₂ bottle 110 enables a short, direct coupling between regulator 153 and O₂ that is robust and substantially resistant to damage.

In embodiments, recessed regulator 153 serves as a lid that closes the opening to O₂ bottle 110. The many configurations for connecting regulator 153 to O₂ bottle 110 are well known to those familiar with the art.

In embodiments, bottle housing 157 and/or canister housing 120 protect O₂ bottle 110 from impact damage should a user drop emergency escape breathing device 100, for example during flight. Alternatively or additionally, bottle housing 157 and/or canister housing 120 protect O₂ bottle 110 from heat buildup that could potentially cause a burn on the user if O₂ bottle 110 is touched during flight.

In embodiments, rapid release demand valve 125 responds to light pressure; such light pressure being supplied by counter lung 160, for example when counter lung 160 has collapsed due to consumption of homogenous air 180 at a rate greater than release of O₂ at approximately 1.2-1.5 liters of O₂ per minute noted above.

The light pressure on rapid release demand valve 125 from counter lung 160 activates a rapid burst of O₂ 168 from O₂ bottle 110, at approximately 80 liters of O₂ per minute, noted above, to immediately supply a fast burst of O₂ to counter lung 160.

In embodiments, as compressed O₂ 168 in O₂ bottle 110 expands, O₂ bottle 110 cools. As enriched O₂ 180 flows in passage 112 along cooled O₂ bottle 110, enriched air 180 loses heat associated with the user body temperature and the above-noted exothermic chemical reactions in adsorption canister 121, and becomes cooled air 186. This arrangement, whereby hot air 180 becomes cooled air 186 through contact with O₂ bottle 110, ensures that the user receives a supply of inspired purified air 186 at a comfortable temperature, helping to prevent user panic and shock noted above.

In embodiments, mouthpiece 140 includes a back pass capillary valve 192 and a forward pass capillary regulator 194. As expired air 122 is expired forward from mouthpiece into canister 121, back pass capillary valve 192 closes to prevent back passing air 186 from passing through mouthpiece 140. Conversely, as cooled air 186 is inspired through mouthpiece, 140 forward pass capillary regulator 194 closes to prevent forward passing expired air 122 from passing through mouthpiece 140.

The light weight of emergency escape breathing device 100 allows a user to rapidly escape a hostile environment; the large capacity of counter lung 160 allows extended breathing while regulator 153 is protected from damage.

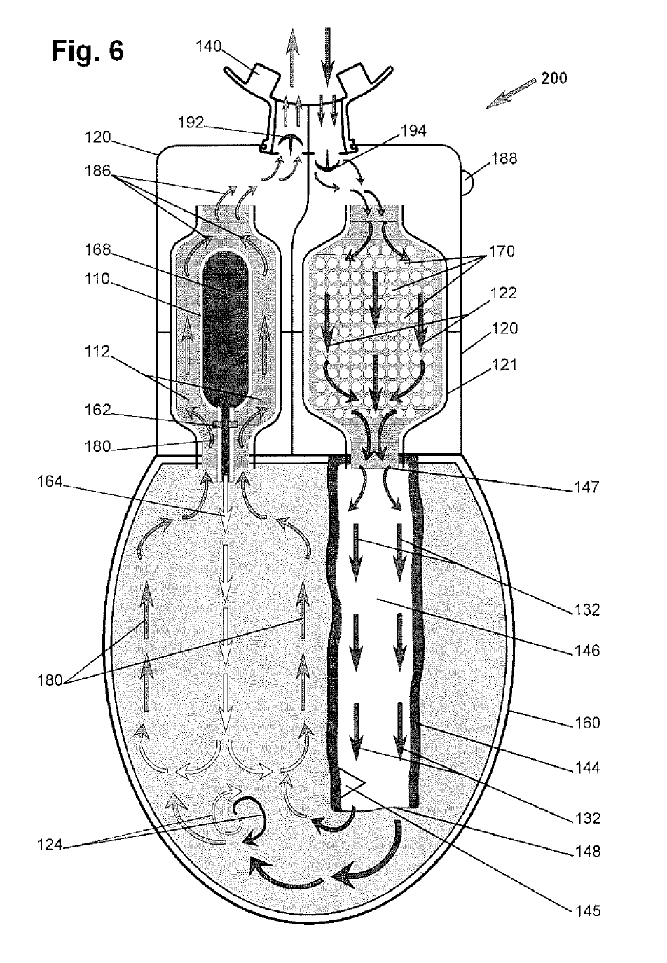

Referring to FIG. 6, a rebreather 200 comprises an elongate sleeve 144 that extends from canister 121 substantially into counter lung 160 and has an opening 148 substantially distant from canister 121. As sleeve 144 releases purified air 132 substantially distant from canister 121, purified air 132 passing from sleeve opening 148 substantially mixes 124 with O₂ 164.

In an embodiment, at least a portion of sleeve 144 comprises a flexible material. Alternatively, at least a portion of sleeve is semi-flexible, semi-rigid and/or rigid, for example comprising several rigid sections that either telescope one into the other or are flexibly connected one to the other.

In an embodiment, substantial mixing 124 resulting in substantially homogenous air 180, purified of CO₂ and enriched with O₂. Purified air 180 then returns to mouthpiece 140 by passing back from counter lung 160, enriched with O₂ 164 ensuring that the user continually receives a proper amount of O₂ 164 in each inspiration. Enriched air 180 for inspiration passes back to mouthpiece through a return passage 112 that directs air 180 from counter lung 160 to mouthpiece 140.

As used herein, “forward passing air” refers to exhaled air 122 passing through mouthpiece 140, through canister housing 120 and canister 121 and into counter lung 160; and “back passing air” or “returning air” refers to air 180 passing from counter lung 160 through canister housing 120 and through mouthpiece 140, to be inspired by a user after which air 186 is recycled as forward passing exhaled air 122.

As used herein, “recycling” refers to air 180 that is inspired by a user from rebreather 200 and that is thereafter expired by the user as expired air 122 through mouthpiece 140, into rebreather 200.

In an embodiment, as compressed O₂ 168 in bottle 110 expands, bottle 110 cools. As enriched O₂ 180 flows in passage 112 along cooled bottle 110, enriched air 180 loses heat associated with the user body temperature and the above-noted exothermic chemical reactions in adsorption canister 121, and becomes cooled air 186. This arrangement, whereby hot air 180 becomes cooled air 186 through contact with bottle 110, ensures that the user receives a supply of returning air 186 at a comfortable temperature, helping to prevent user panic and shock noted above.

When drawing air 180 in a heated environment, for example in a burning building, cooled air 186 becomes all the more important, with bottle 110 cooling the searing heat of air 180 caused by the fire and aiding the user to remain alert in spite of the heat from a nearby fire.

In an embodiment, expired air 122 retains a portion of the cooling inherent in cooled air 186 as air 122 recycles following exhalation. Retained cooling within expired air 122 thereby cools soda-lime granules 170 in canister 121 that become heated due to the exothermic adsorption of granules 170. Cooling granules 170 increase the efficiency of the exothermic CO₂ adsorption process in canister 121, by reducing the heat of the exothermic reaction. Cooled granules 170 thereby increase the percentage of CO₂ adsorbed from air 122 in each breathing cycle, yielding greater purity in purified air 132.

In embodiments, rebreather 200 is compact, lightweight and easily dispensed to a user by emergency personnel. In providing rebreather 200 to a victim, mouthpiece 140 is simply placed in the victim's mouth, counter lung 160 is tucked under the victim's chin and rebreather 200 is activated to instantly supply O₂ 164 on the first inspiration. The instant supply of O₂ 164 prevents the user from choking as would be the case were the user to attempt a first inspiration from a deflated counter lung 160.

During the first expiration, air 122 enters canister 121 and during a second expiration, air 132 enters sleeve 144. With a third expiration, purified air 132 moves out of a sleeve opening 148 while sleeve 144 creates impedance within air 132.

Impedance on air 132 slows the speed at which air 132 leaves sleeve 144, decreasing the speed of unpurified air 122, thereby increasing the contact time of unpurified air 122 with soda-lime granules 170; accruing efficiency in the adsorption of CO₂ from expired air 122.

Optionally, sleeve 144 includes a restriction 145 that restricts sleeve passage 146 and further decreases the speed of air 122, thereby increasing contact time with granules 170 and purification efficiency of expired air 122.

Restriction 145 is shown as a single invagination of sleeve passage 146 but could take many forms, inter alia, multiple invaginations and/or partial closure of opening 148. Alternatively, restriction of passage 132 may constitute a complete closure of opening 148 and one or more openings may be included in the wall of passage 146.

In addition, as mentioned above, the cooler overall temperature of air 122 as a result of cooled air 186 allows the exothermic reaction to proceed at lower temperatures, accruing greater efficiently in the removal of CO₂ from expired air 122.

Continuing with the initial function of rebreather 200; the user's third expiration of air 122 results in the substantial mixing 124 in counter lung 160, mentioned above. With the user's fourth expiration, homogenous enriched air 180 enters passage 112 to become cooled air 186. All this time, the user has been able to inspire O₂ 164 due to the constant supply of O₂ 164 from O₂ bottle 110, preventing choking. With the user's fifth expiration, the user begins to inspire cooled air 186 that passes through mouthpiece 140.

The efficient supply of life-sustaining O₂ 164 and/or air 186 at a comfortable temperature, from the first inspiration and onward, allows the user to immediately proceed toward safety without wasting time waiting for air 186, or choking in the absence of air 186.

Additionally, emergency personnel need not waste time assisting a choking user in acclimating to use of rebreather 200, or attempting to fix a jammed breathing cycle demand valve or rapid release demand valve; thereby allowing the emergency personnel to immediately continue searching for other victims; potentially saving more lives due to the advantageous construction of rebreather 200.

Perhaps more important, the light weight of rebreather 200 allows each emergency personnel to carry multiple rebreathers 200 on search and rescue missions. Emergency personnel can quickly dispense rebreather 200 to a victim, direct the victim to safety, for example a safety exit in a building, and immediately continue searching for other victims, armed with additional rebreathers 200.

While the design of rebreather 200 may vary, it is postulated that emergency personnel may carry multiple small and lightweight rebreathers 200, in holsters extending from a custom waste belt (not shown). In addition to allowing efficient dispensing of multiple rebreathers 200 in an emergency, such an arrangement frees up the hands of the emergency personnel for better uses, for example opening a fire exit or operating a fire extinguisher to provide fire-free access to an emergency exit.

Once a user reaches safety, use of rebreather 200 may continue until emergency personnel outside the burning building determine that the threat of hypoxia and shock has passed and remove rebreather 200. Alternatively, as bottle 110 substantially empties of O₂ 164, the pressure of oxygen 164 falls below a predetermined threshold and causes an audio and/or visual indicator 188 to indicate that rebreather 200 must be replaced by the emergency personnel.

Many variations may be made in rebreather 200, for example substituting a combination nose and mouthpiece manifold (not shown) for mouthpiece 140 or including a hood that covers the head. Additionally or alternatively, canister housing 120 and/or counter lung 160 may be supplied in any one of alternative shapes or sizes, the many variations being well known to those familiar with the art.

The present invention has been described with particular reference to applications in the presence of fire. However, additional uses will be readily apparent to those familiar with the art. Consequently, it should be understood that this description is provided without prejudice to the generality of the invention or its range of applications. Additional applications, objects, advantages, and novel features of the present invention will become apparent to one ordinarily skilled in the art upon examination of the above noted examples, which are not intended to be limiting.

It is expected that during the life of this patent many relevant systems will be developed and the scope of the terms of the rebreather unit and method of application is intended to include all such new technologies a priori; for example soda-lime has been cited as an adsorbent, however the invention contemplates any CO₂ adsorbent that potentially can be used, or that will be used now or in the future.”

It is appreciated that certain features of the invention that are, for clarity, described in the context of separate embodiments, may also be provided in combination in a single embodiment. Conversely, various features of the invention, which are, for brevity, described in the context of a single embodiment, may also be provided separately or in any suitable subcombination.

Accordingly, the invention is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

As used herein the term “about” refers to ±10%. The terms “include”, “comprise” and “have” and their conjugates as used herein mean “including but not necessarily limited to.”

It will be appreciated by a person skilled in the art that the present invention is not limited by what has thus far been described. Rather, the scope of the present invention is limited only by the following claims.

1. A rebreather device, comprising:
a) a housing adapted to allow forward and backward passage of air during operation of the rebreather;
b) a CO₂ adsorbing canister contained within the housing;
c) a counter lung extending from the housing, such that during rebreather operation, a volume of air passes forward through the housing and canister, into the counter lung and from the counter lung back through the housing, after which the volume of air is recycled as forward passing air;
the rebreather further includes a bottle of compressed O₂ operatively associated with the housing and adapted to continuously release O₂ gas into the counter lung during at least a portion of the rebreather operation.

2. The device according to claim 1 and including a valve on said bottle that remains open during said at least one forward passing, back passing and recycling of air during said operation.

3. The device according to claim 1, wherein at least one portion of said bottle is adapted to cool during said continuous release.

4. The device according to claim 3, wherein said bottle includes a passage through which at least one portion of said volume of back passing air passes.

5. The device according to claim 4, wherein said at least one portion of said back passing air volume passes through said bottle passage, contacts said at least one portion of said cooled bottle, such that said at least one portion of air cools.

6. The device according to claim 5, wherein said at least one portion of said back passing air volume substantially retains at least one portion of said cooling as the air volume is recycled as forward passing air.

7. The device according to claim 6, wherein said retained cooling of said at least one portion of said forward passing air volume, cools at least a portion of the CO₂ adsorbing canister.

8. A method for cooling for air in rebreather, comprising:
a) continuously expanding O₂ gas from a bottle of compressed O₂ gas;
b) cooling said bottle with said expanding;
c) forward passing and backward passing a volume of warm air within the rebreather;
d) passing said backward passing volume proximate to said bottle;
e) exchanging heat between said volume and said bottle; and
f) cooling said volume.

9. The method according to claim 8, further including:
recycling said cooled volume.

10. An emergency escape breathing device, comprising:
an oxygen bottle configured to contain compressed oxygen;
an oxygen release regulator that releases said compressed oxygen at a constant rate during use of said emergency escape breathing device, said oxygen release regulator being substantially contained within said oxygen bottle.

11. The device according to claim 10, wherein said oxygen bottle comprises a substantially monotonous configuration.

12. The device according to claim 10, wherein said oxygen bottle is contained within a protective housing.

13. The device according to claim 12, wherein said protective housing is configured to protect said oxygen bottle against at least one of:
impact; and
heat buildup.

14. The device according to claim 10, wherein said oxygen bottle is configured to contain dry oxygen.

15. The device according to claim 14, wherein said oxygen release regulator is configured to release said dry oxygen at said constant rate.

16. The device according to claim 10, including a counter lung comprising a chamber, said chamber in an unexpanded configuration being enclosed by at least two substantially parallel walls and a perimeter connecting said at least two substantially parallel walls, said perimeter including at least one fold that substantially extends into said chamber.

17. The device according to claim 16, wherein when said chamber is in an expanded configuration, said at least one fold substantially unfolds and at least a portion of said two walls diverge.

18. The device according to claim 16, including forward and backpass valves operatively associated with said counter lung.

19. The device according to claim 1S, wherein said forward and backpass valves promote a circular airflow within said device.

20. An emergency escape breathing device, comprising: a counter lung comprising a chamber, said chamber in an unexpanded configuration being enclosed by at least two substantially parallel walls and a perimeter connecting said at least two substantially parallel walls, said perimeter including at least one fold that substantially extends into said chamber.

21. The device according to claim 20, wherein when said chamber is in an expanded configuration, said at least one fold substantially unfolds and at least a portion of said two walls diverge.

22. An emergency escape breathing device, comprising:
an oxygen bottle configured to contain compressed oxygen;
an oxygen release regulator configured to release said compressed oxygen at a constant rate during use of said emergency escape breathing device, said oxygen release regulator being substantially contained within said oxygen bottle; and
a counter lung comprising a chamber, said chamber in an unexpanded configuration being enclosed by at least two substantially parallel walls and a perimeter connecting said at least two substantially parallel walls, said perimeter including at least one fold that substantially extends into said chamber.

23. The device according to claim 22, wherein when said chamber is in an expanded configuration, said at least one fold substantially unfolds and at least a portion of said two walls diverge.

24. The device according to claim 22, wherein said oxygen bottle comprises a substantially monotonous configuration.

25. The device according to claim 22, wherein said oxygen bottle is contained within a protective housing.

26. The device according to claim 25, wherein said protective housing is configured to protect said oxygen bottle from at least one of:
impact; and
heat buildup.
